(19) United States
(12) Patent Application Publication
(10) Pub. No.: US 2009/0327803 A1
(43) Pub. Date: Dec. 31, 2009

(54) STORAGE CONTROL DEVICE AND STORAGE CONTROL METHOD

(75) Inventors: Kazuhiro Fukutomi, Kanagawa (JP); Hideaki Sato, Kanagawa (JP); Shinichi Kanno, Tokyo (JP); Shigehiro Asano, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/395,811

(22) Filed: Mar. 2, 2009

(30) Foreign Application Priority Data
Jun. 30, 2008 (JP) 2008-171800

(51) Int. Cl. G06F 11/20

(52) U.S. Cl. 714/7; 714/6; 714/E11.084; 714/E11.085

(57) ABSTRACT

A RAID is configured using plural nonvolatile semiconductor memory devices to enable recovery of data stored in the nonvolatile semiconductor memory devices, and data is read from the nonvolatile semiconductor memory device included in the RAID in response to a data reading request inputted from outside. When an error occurs during the reading, data for which the reading error occurs is recovered, and rewritten into an area of the nonvolatile semiconductor memory device in which the reading error occurs.

### CROSS-REFERENCE TO RELATED APPLICATIONS

This application is based upon and claims the benefit of priority from the prior Japanese Patent Application No. 2008-171800, filed on Jun. 30, 2008; the entire contents of which are incorporated herein by reference.

### BACKGROUND OF THE INVENTION

1. Field of the Invention

The present invention relates to a storage control device and a storage control method for controlling plural nonvolatile semiconductor memory devices arranged in a redundant array of independent/inexpensive disks (RAID).

2. Description of the Related Art

Typically, in a storage system applied in a server environment and the like, plural magnetic disk devices are used to configure a RAID to improve fault tolerance and redundancy (for example, see “A Case for Redundant Array of Inexpensive Disks (RAID)”, by D. Patterson, G. Gibson, and R. Katz, Proceedings of the 1988 ACM SIGMOD, pp. 109 to 116, June 1988). For example, in a RAID 5 configuration, three or more magnetic disk devices are used. Parities for data recovery and relevant data to be distributed are stored separately in different corresponding magnetic disk devices. In this way, even when data are damaged, the data can be recovered by using these parities. In a controller that implements the RAID configuration, when reading of data from one of the magnetic disk devices becomes impossible, usually this magnetic disk device is determined to have failed and excluded from the RAID configuration. The original RAID configuration can be restored by providing a new magnetic disk device in place of the excluded magnetic disk device.

Meanwhile, a nonvolatile semiconductor memory device that applies a nonvolatile semiconductor memory element as a recording medium, such as a solid state drive (SSD), is used as an auxiliary storage (secondary storage), like the magnetic disk device. Because the nonvolatile semiconductor memory device has no disk, unlike the magnetic disk device, reading or writing of data is performed at a higher speed than the magnetic disk device, and power consumption is lower. Accordingly, the nonvolatile semiconductor memory device is expected to be applied in the server environment.

In a nonvolatile semiconductor memory device having a NAND flash memory applied as a recording medium, stored data can be degraded due to self-discharge, charge displacement occurring during data reading, or the like, which may prevent the data from being read correctly. Accordingly, the nonvolatile semiconductor memory device has a mechanism that performs a refresh process at specific time intervals for reading data stored therein, performing error correction, and then rewriting the data in the NAND flash memory, thereby preventing data loss. Because the memory element (memory cell) itself does not fail and only the data is degraded, the memory element can be made available again when correct data is written again.

However, depending on the level of the degradation, all the data cannot always be recovered by the refresh process. When the recovery of data fails, error occurs during reading thereof. Accordingly, when the RAID is configured using the nonvolatile semiconductor memory devices, and when a reading error occurs in a nonvolatile semiconductor memory device, it is determined that the nonvolatile semiconductor memory device fails, like in the conventional technique. The nonvolatile semiconductor memory device that is determined faulty may be restored by writing correct data in an area that stores therein the data for which the reading error occurs, as described above. However, the conventional technique assumes the use in the magnetic disk device, and thus the nonvolatile semiconductor memory device cannot be restored. Even when the nonvolatile semiconductor memory device is restorable, the nonvolatile semiconductor memory device may be excluded from the RAID configuration to be replaced with a new one. Therefore, in the conventional technique, the nonvolatile semiconductor memory devices cannot be utilized effectively.

### SUMMARY OF THE INVENTION

According to one aspect of the present invention, a storage control device includes at least one interface capable of connecting to plural nonvolatile semiconductor memory devices, a configuring unit that configures a redundant array of independent/inexpensive disks (RAID) for storing therein storage target data and recovery information that enables recovery of the storage target data, the RAID including the plural nonvolatile semiconductor memory devices, a reading unit that reads data from the nonvolatile semiconductor memory devices included in the RAID, in response to a data reading request inputted from outside, a recovering unit that recovers data for which an error occurs during reading by the reading unit, based on the recovery information, a storing unit that temporarily stores therein the data recovered by the recovering unit, and a writing unit that writes the data stored in the storing unit, into an area of the nonvolatile semiconductor memory device in which the reading error for the data occurs.

According to another aspect of the present invention, a storage control method of a storage control device which configures a redundant array of independent/inexpensive disks (RAID) for storing therein storage target data and recovery information that enables recovery of the storage target data using plural nonvolatile semiconductor memory devices is provided. The method includes reading data from the nonvolatile semiconductor memory devices included in the RAID, in response to a data reading request inputted from outside, recovering data, for which an error occurs during reading in the reading, based on the recovery information, temporarily storing the data recovered in the recovering, writing the data stored in the temporarily storing, into an area of the nonvolatile semiconductor memory device in which the reading error for the data occurs.

### BRIEF DESCRIPTION OF THE DRAWINGS

FIG. 1 depicts a configuration of a storage system;

FIG. 2 is a schematic diagram of storage areas when a storage device has a RAID 5 configuration;

FIG. 3 depicts a configuration of a controller according to a first embodiment of the present invention;

FIG. 4 is a flowchart of a writing process procedure according to the first embodiment;

FIG. 5 is a flowchart of a reading process procedure according to the first embodiment;

FIG. 6 depicts a configuration of a controller according to a second embodiment of the present invention;

FIG. 7 is a schematic diagram of storage areas when a storage device has a RAID 1 configuration;

FIG. 8 is a flowchart of a writing process procedure according to the second embodiment; and

FIG. 9 is a flowchart of a reading process procedure according to the second embodiment.

### DETAILED DESCRIPTION OF THE INVENTION

Exemplary embodiments of the present invention will be explained below in detail with reference to the accompanying drawings. The present invention is not limited to the following descriptions, and various modifications can be made without departing from the scope of the invention.

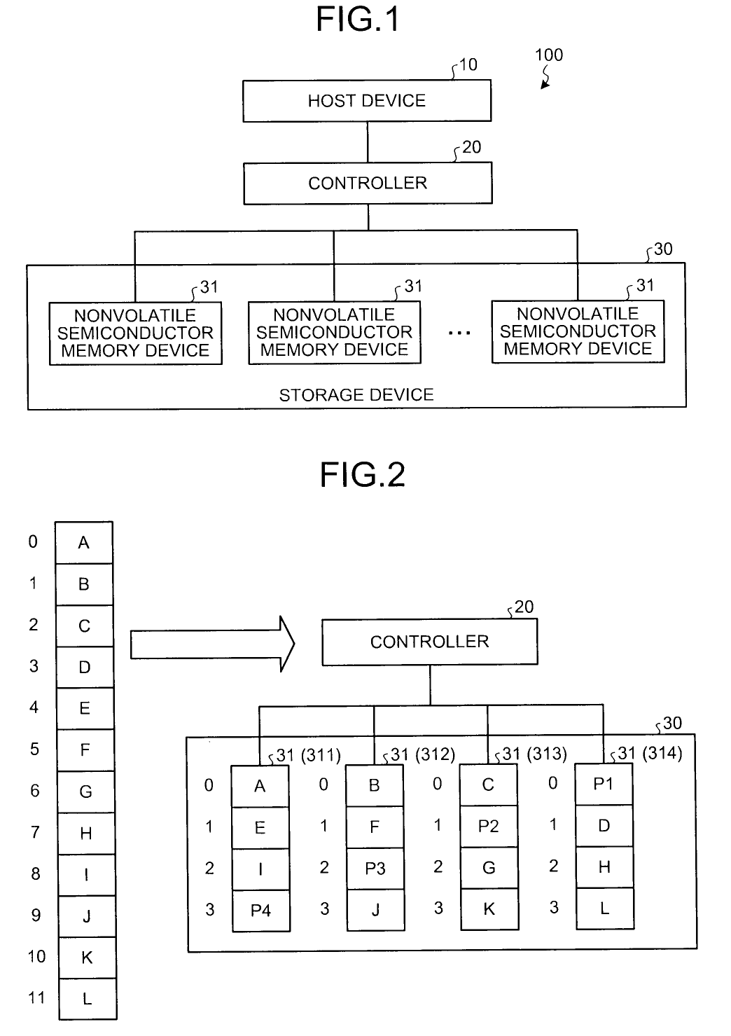

FIG. 1 is a schematic block diagram of a configuration of a storage system 100 according to a first embodiment of the present invention. As shown in FIG. 1, the storage system 100 includes a host device 10, a controller 20, and a storage device 30 including plural nonvolatile semiconductor memory devices 31. The host device 10 is a personal computer (PC), or the like, and outputs instruction information to the controller 20 to request writing or reading of data. Instruction information for requesting writing of data is hereinafter referred to as “writing request”, and instruction information for requesting reading of data is referred to as “reading request”. It is assumed that a writing request outputted from the host device 10 to the controller 20 includes at least data to be written, and that a reading request includes address information (for example, logical block addressing (LBA)) of the storage device 30 as a reading source.

The controller 20 manages the plural nonvolatile semiconductor memory devices 31 included in the storage device 30 using the RAID technique. The controller 20 performs writing or reading of data into or from storage areas that are logically formed by the plural nonvolatile semiconductor memory devices 31, in response to a request from the host device 10.

More specifically, the controller 20 realizes fault tolerance and redundancy of the storage device 30 by arranging the plural nonvolatile semiconductor memory devices 31 in any one of RAID 1, RAID 5, and RAID 6, a combination thereof, or other RAID system. A mode in which the storage device 30 has a RAID 5 configuration is explained as the first embodiment.

In the RAID 5, a memory device assigned to store an error correcting code called “parity” and memory devices assigned to store data are changed in turn in each stripe. A disk array device that implements the RAID 5 can realize improvement of the fault tolerance, increase in the capacity, and speed-up of the reading process.

FIG. 2 is a schematic diagram of storage areas in the storage device 30 with the RAID 5 configuration. FIG. 2 is an example in which the storage device 30 includes four nonvolatile semiconductor memory devices 31 (nonvolatile semiconductor memory devices 311 to 314), and twelve data A to L are stored in the storage areas of the storage device 30.

The storage areas of the nonvolatile semiconductor memory devices 31 that configure the RAID 5 are divided by the controller 20 into plural logical blocks as units of writing or reading of data. In the example shown in FIG. 2 an area in which each of the data A to L or each of parities P1 to P4 is stored corresponds to one logical block.

Each of the parities P1 to P4 is recovery information calculated from plural data stored in the same stripe group (0 to 3), and data, from which the recovery information is generated, can be recovered based on the recovery information. For example, the parity P1 is generated from the data A, B, and C stored in a stripe group 0 (zero), and even when an error occurs in any one of the data A, B, and C, the data in which the error occurs can be recovered from the remaining data and the parity P1. The logical blocks in which the data are stored, and the logical blocks in which the parities are stored (hereinafter, “parity areas”) are determined according to a given rule. Arrangement positions of the logical blocks are not limited to those in the example shown in FIG. 2.

The storage device 30 includes the plural nonvolatile semiconductor memory devices 31 each having a nonvolatile semiconductor element such as a NAND flash memory as a recording medium. The storage device 30 serves as a storage that stores therein data under RAID management by the controller 20. The number of the nonvolatile semiconductor memory devices 31 included in the storage device 30 can be any as long as the number meets requirements of the RAID applied by the controller 20 (for example, two or more in the case of RAID 1, and three or more in the case of RAID 5).

### <Configuration of Controller 20>

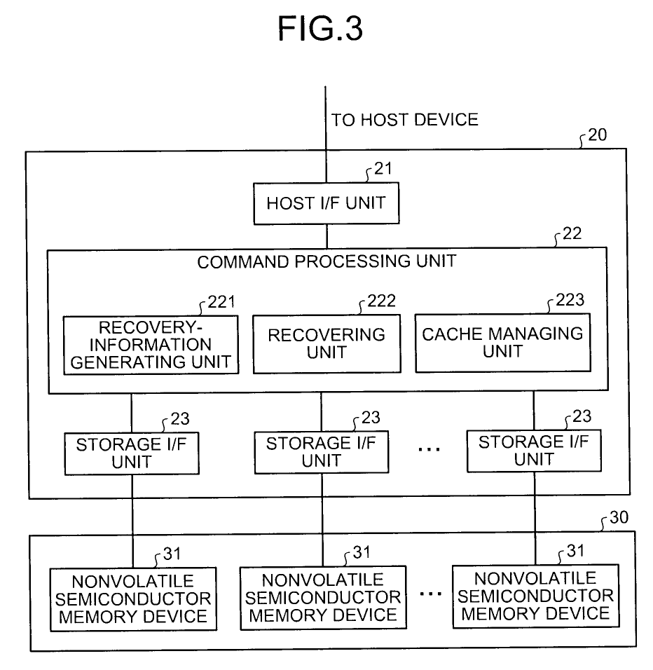

A configuration of the controller 20 is explained in detail with reference to FIG. 3. FIG. 3 is a block diagram of a specific configuration of the controller 20. As shown in FIG. 3, the controller 20 includes a host interface (I/F) unit 21, a command processing unit 22, and storage I/F units 23.

The host I/F unit 21 is an interface device for connecting to the host device 10, and controls transmission or reception of data between the host device 10 and the controller 20 (the command processing unit 22).

The command processing unit 22 includes a recovery-information generating unit 221, a recovering unit 222, and a cache managing unit 223. The command processing unit 22 performs writing or reading of data into or from the storage device 30 through the storage I/F unit 23, in response to a request inputted from the host device 10 through the host I/F unit 21.

The command processing unit 22 includes processors such as an application specific integrated circuit (ASIC) and a central processing unit (CPU), and memories such as a read only memory (ROM) that stores therein predetermined programs for controlling operations of the controller 20 and a random access memory (RAM) that serves as a work area of the processors (all not shown). The command processing unit 22 realizes functional units of the recovery-information generating unit 221, the recovering unit 222, and the cache managing unit 223 in cooperation with the processors and the programs stored in the memory.

The recovery-information generating unit 221 is a functional unit that generates a parity of writing target data. When some existing data is included in a writing destination area, the recovery-information generating unit 221 generates a new parity from the existing data, a parity associated with the existing data, and the writing target data.

The recovering unit 222 is a functional unit that recovers data for which a reading error occurs, using other data and a party stored in the same stripe that includes the data for which the reading error occurs.

The cache managing unit 223 is a functional unit that temporarily stores therein and manages data to be written into the nonvolatile semiconductor memory device 31 and data read from the nonvolatile semiconductor memory device 31, and temporarily stores therein data recovered by the recovering unit 222 at the time of occurrence of a reading error.

The command processing unit 22 controls writing or reading of data into or from the storage device 30 in cooperation with the functional units as described above (the recovery-information generating unit 221, the recovering unit 222, and the cache managing unit 223).

More specifically, when receiving a data writing request from the host device 10, the command processing unit 22 identifies an area (logical block) in one of the nonvolatile semiconductor memory devices 31 corresponding to a writing destination for the data. The recovery-information generating unit 221 generates a parity based on the writing target data. The command processing unit 22 then requests the nonvolatile semiconductor memory device 31 as the writing destination to write the data into the identified area and to write a parity into a parity area corresponding to the identified area. In this way, the writing target data and the parity for the data are written into the storage device 30.

When some existing data is included in the writing destination area, the existing data is to be updated with new data. In this case, the command processing unit 22 requests the relevant nonvolatile semiconductor memory device 31 to read the existing data stored in the area identified as the writing destination and the parity associated with the data, thereby reading the existing data and the parity. At this time, the recovery-information generating unit 221 generates a new parity from the read existing data and parity, and the writing target data. The recovery-information generating unit 221 stores generated new parity and the writing target data in the cache managing unit 223, to be written into the relevant area in the nonvolatile semiconductor memory device 31, thereby updating the data.

When receiving a data reading request from the host device 10, the command processing unit 22 identifies an area (logical block) in one of the nonvolatile semiconductor memory devices 31 corresponding to a reading source. The command processing unit 22 requests the nonvolatile semiconductor memory device 31 as the reading source to read data from the identified area, thereby reading the reading target data from the storage device 30 and outputting the data to the host device 10.

When the recording medium of the nonvolatile semiconductor memory device 31 is a NAND flash memory, data in the memory cell may be corrupted due to self-discharge or charge displacement occurring during data reading. A memory device that has a NAND flash memory as a recording medium usually has a mechanism for detecting and correcting errors in corrupted data. However, not all the errors can be always corrected, and, in such a case, an error occurs during data reading. In the first embodiment, to overcome the data corruption, the recovering unit 222 recovers the data for which a reading error occurs, based on the parity for the data, and temporarily stores the recovered data in the cache managing unit 223. When a writing request for the relevant area is received, data to be written is generated based on the data in the cache, and then written in the relevant area, thereby recovering the nonvolatile semiconductor memory device 31. Accordingly, the nonvolatile semiconductor memory device 31 in which the reading error occurs can be restored to a normal state.

The storage I/F unit 23 is an interface device for connecting to the nonvolatile semiconductor memory device 31, and controls transmission or reception of data between the controller 20 (the command processing unit 22) and the nonvolatile semiconductor memory device 31. It is assumed that the storage I/F unit 23 is provided for each of the nonvolatile semiconductor memory devices 31. However, one storage I/F unit 23 and the plural nonvolatile semiconductor memory devices 31 can be connected to each other.

### <Operations of Controller 20>

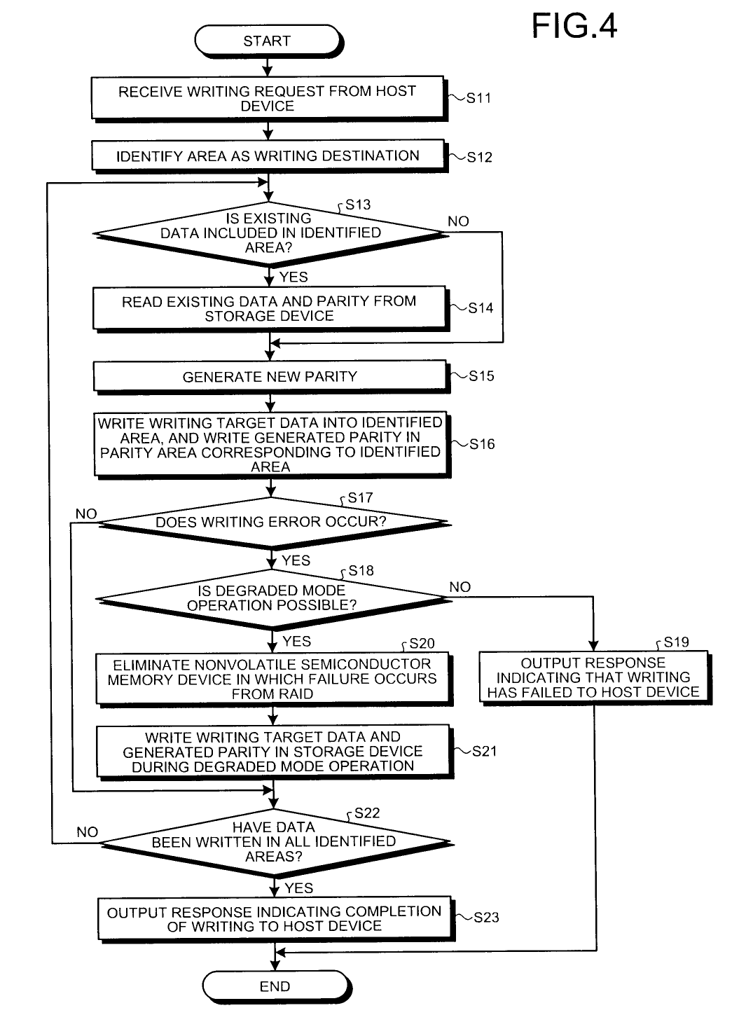

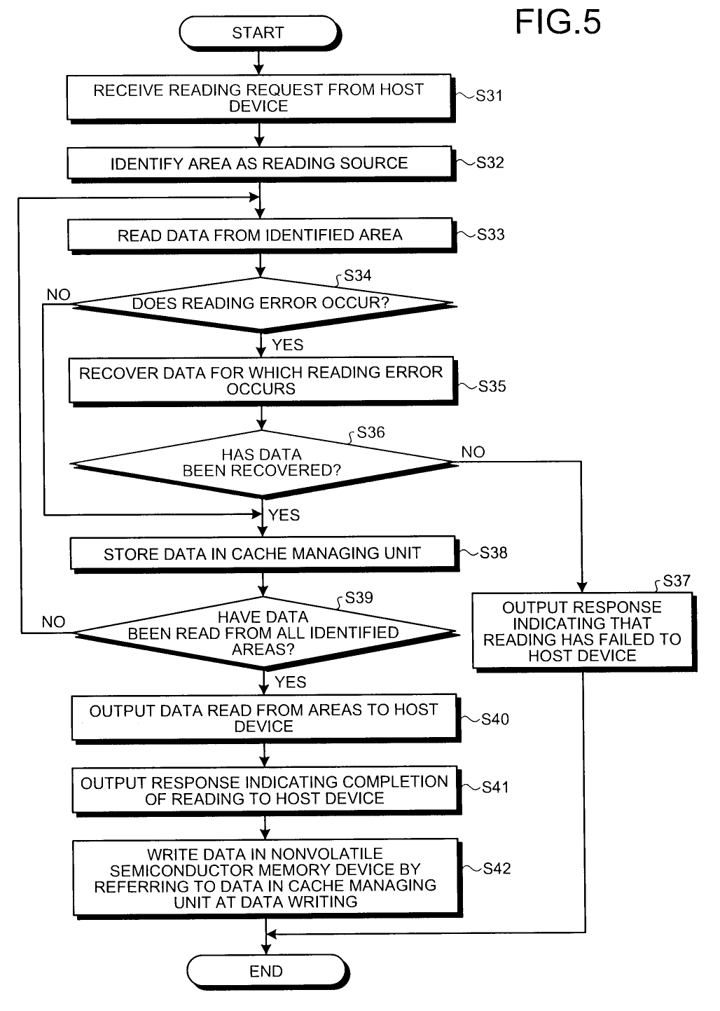

Operations of the controller 20 are explained. An operation performed to write data in the storage device 30 is first explained with reference to FIG. 4. FIG. 4 is a flowchart of a writing process procedure performed by the controller 20. This process assumes that the storage device 30 has the RAID 5 configuration, and that writing or reading of data is performed in units of stripes of the storage device 30.

When receiving a data writing request from the host device 10 through the host I/F unit 21 (Step S11), the command processing unit 22 first identifies an area in one of the nonvolatile semiconductor memory devices 31 corresponding to an area as a writing destination (Step S12). The writing destination can be one area or plural areas.

The recovery-information generating unit 221 then determines whether any existing data is stored in the area identified at Step S12 (Step S13). When determining that the existing data is stored (YES at Step S13), the recovery-information generating unit 221 issues a request for reading of data and a parity with respect to the area identified at Step S12 to the storage device 30 through the storage I/F unit 23, thereby reading the existing data and the parity associated with the data from the storage device 30 (Step S14).

The recovery-information generating unit 221 then generates a new parity from the existing data and the parity read at Step S14, and the writing target data (Step S15), and then proceeds to a process at Step S16.

When a reading error occurs during the reading at Step S14, other data that are stored in the same stripe as the existing data for which the reading error occurs are read from the storage device 30, and a new parity is generated from the read other data and the writing target data.

When determining at Step S13 that no existing data is included (NO at Step S13), the recovery-information generating unit 221 generates a parity from the writing target data (Step S15), and then proceeds to a process at Step S16.

The command processing unit 22 then writes the writing target data into the area identified at Step S12, and writes the parity generated at Step S15 into a parity area corresponding to the writing area for the writing target data (Step S16). The command processing unit 22 determines whether a writing error occurs during writing of at least one of the data and the parity thereof. When determining that the writing is correctly performed (NO at Step S17), the command processing unit 22 directly proceeds to a process at Step S22.

When a writing error is detected at Step S17 (YES at Step S17), the command processing unit 22 determines that a failure occurs in the nonvolatile semiconductor memory device 31 as the writing destination. The command processing unit 22 then determines whether a degraded mode operation for maintaining the RAID 5 configuration is possible in the remaining nonvolatile semiconductor memory devices 31 other than the faulty nonvolatile semiconductor memory device 31 (Step S18). When determining that the degraded mode operation is impossible (NO at Step S18), the command processing unit 22 outputs a response indicating that the writing has failed to the host device 10 (Step S19), thereby terminating the process.

When determining that the degraded mode operation is possible (YES at Step S18), the command processing unit 22 eliminates the faulty nonvolatile semiconductor memory device 31 from the RAID 5 configuration (Step S20). The command processing unit 22 then writes the writing target data and the parity generated at Step S15 into the storage device 30 that is in the degraded mode operation (Step S21), and then proceeds to a process at Step S22.

At Step S22, the command processing unit 22 determines whether data have been written in all the areas identified at Step S12. When determining that there is an unprocessed area (NO at Step S22), the command processing unit 22 returns to the process at Step S13, to process an area included in another stripe. When determining that data have been written in all the areas identified at Step S12 (YES at Step S22), the command processing unit 22 outputs a response indicating that the writing is completed to the host device 10 (Step S23), thereby terminating the process.

An operation performed to read data from the storage device 30 is explained with reference to FIG. 5. FIG. 5 is a flowchart of a reading process procedure performed by the controller 20. This process assumes that the storage device 30 has the RAID 5 configuration, and writing or reading of data is performed in units of stripes in the storage device 30.

When receiving a data reading request from the host device 10 through the host I/F unit 21 (Step S31), the command processing unit 22 first identifies an area in one of the nonvolatile semiconductor memory devices 31 corresponding to an area as a reading source (Step S32). The reading source can be one area or plural areas.

The command processing unit 22 then issues a request for reading data in the area identified at Step S12 to the nonvolatile semiconductor memory device 31 corresponding to the identified area, thereby reading data to be read (reading target data) from the storage device 30 (Step S33). At this time, the command processing unit 22 determines whether a reading error occurs during the reading at Step S33 (Step S34). When determining that the reading is performed correctly (NO at Step S34), the command processing unit 22 stores the read data into the cache managing unit 223 (Step S38), and then proceeds to a process at Step S39.

Meanwhile, when the command processing unit 22 determines at Step S34 that a reading error occurs (YES at Step S34), the recovering unit 222 reads unread data and a parity that are stored in the same stripe group as that of the data for which the reading error occurs, from the storage device 30. The recovering unit 222 then recovers the data for which the reading error occurs from the unread data and the parity, and the data read at Step S33 (Step S35).

The recovering unit 222 then determines whether the data has been recovered in the process at Step S35. When determining that the data cannot be recovered because the parity cannot be read, or the like (No at Step S36), the recovering unit 222 outputs a response indicating that the reading has failed to the host device 10 (Step S37), thereby terminating the process. When determining at Step S36 that the data has been recovered (YES at Step S36), the recovering unit 222 stores the recovered data in the cache managing unit 223 (Step S38), and then proceeds to a process at Step S39.

The command processing unit 22 then determines whether data have been read from all the areas identified at Step S32 (Step S39). When determining that there is any unprocessed area (NO at Step S39), the command processing unit 22 returns to the process at Step S33 to process the remaining area. When determining that data have been read from all the areas identified at Step S32 (YES at Step S39), the command processing unit 22 outputs the data read from all the areas to the host device 10 by referring to the cache managing unit 223 (Step S40). The command processing unit 22 then outputs a response indicating completion of the reading to the host device 10 (Step S41). The command processing unit 22 then refers to the data in the cache managing unit 223 at the time of data writing, to write the data into the nonvolatile semiconductor memory device 31 (Step S42), as described below, thereby terminating the process.

When a reading error occurs at Step S34, it implies that the recovered data is stored only in the cache managing unit 223, which causes a state in which data in the nonvolatile semiconductor memory devices 31 are inconsistent with the data in the cache managing unit 223. However, consistency can be maintained when the writing into the nonvolatile semiconductor memory devices 31 is performed for example by referring to the data in the cache managing unit 223 at the time of writing of the data. Accordingly, it is possible to prevent a situation in which a longer writing time is required when the data are written into the nonvolatile semiconductor memory devices 31, the reading process is not completed, and output to a data requesting source (the host device) is delayed.

As described above, according to the first embodiment, when an error occurs during reading, data for which the reading error occurs is recovered and stored in the cache managing unit 223. The data is then written into an area of the nonvolatile semiconductor memory device 31 in which the reading error occurs when a writing request is issued, so that the nonvolatile semiconductor memory device 31 can be restored to a normal state. In this way, the plural nonvolatile semiconductor memory devices 31 arranged in the RAID can be effectively utilized.

A second embodiment of the present invention is explained. In the first embodiment, the storage device 30 has the RAID 5 configuration. However, as described above, any storage system having a RAID 1 configuration, a RAID 6 configuration, or any other configuration can be applied as long as the storage system is capable of recovering data. The storage device 30 having the RAID 1 configuration is explained below as the second embodiment. The same constituent elements as those in the first embodiment are denoted by like reference numerals and explanations thereof will be omitted.

### <Configuration of Controller 40>

A controller 40 according to the second embodiment is explained. The controller 40 manages two nonvolatile semiconductor memory devices 31 included in the storage device 30 using the RAID 1 technique, and performs writing or reading of data into or from storage areas that are logically formed by the plural nonvolatile semiconductor memory devices 31 in response to an access request from the host device 10.

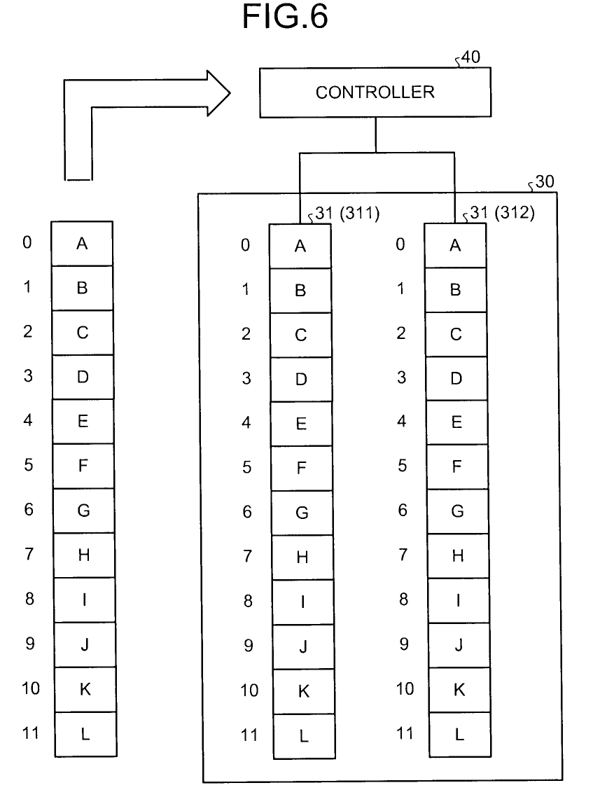

FIG. 6 schematically depicts the storage areas in the storage device 30 having the RAID 1 configuration. The RAID 1 is also called “mirroring”, and the same data are simultaneously written in the same stripe areas of at least two nonvolatile semiconductor memory devices 31 to ensure fault tolerance and redundancy. FIG. 6 is an example in which the storage device 30 includes two nonvolatile semiconductor memory devices 31 (nonvolatile semiconductor memory devices 311 and 312), and twelve data A to L are stored in the storage areas of the storage device 30.

In the case of the RAID 1 configuration, when a data reading error occurs in one of the nonvolatile semiconductor memory devices 31, the same data can be read from the other nonvolatile semiconductor memory device 31, and accordingly the system itself can keep operating without problems.

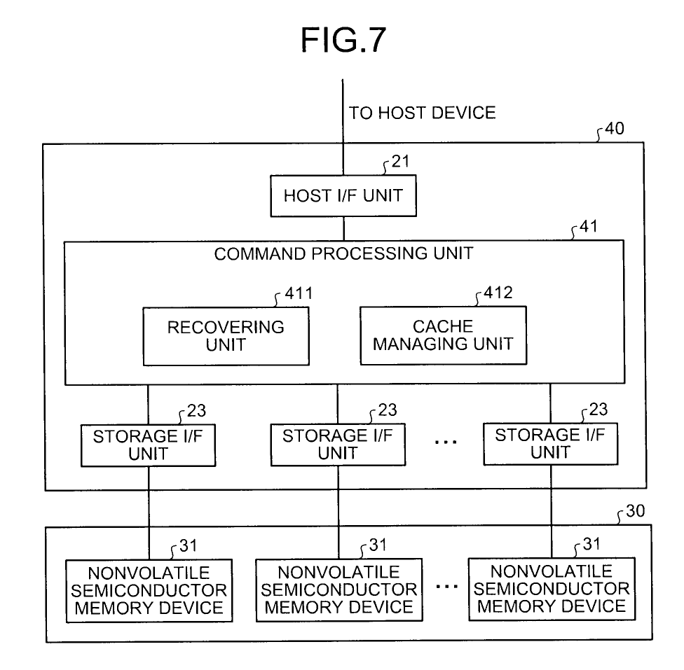

FIG. 7 is a block diagram of a specific configuration of the controller 40 according to the second embodiment. As shown in FIG. 7, the controller 40 includes the host I/F unit 21, a command processing unit 41, and the storage I/F units 23.

The command processing unit 41 includes a recovering unit 411, and a cache managing unit 412. The command processing unit 41 writes or reads data into or from the storage device 30 that is connected through the storage I/F units 23, in response to an access request inputted from the host device 10 through the host I/F unit 21.

The command processing unit 41 includes processors such as an ASIC and a CPU, and memories such as a ROM that stores therein predetermined programs for controlling operations of the controller 40 and a RAM as a work area of the processors (all not shown). The command processing unit 41 realizes functional units of the recovering unit 411 and the cache managing unit 412 in cooperation with the processors and the programs stored in the memory.

More specifically, when receiving a data writing request from the host device 10, the command processing unit 41 identifies an area (logical block) in each of the nonvolatile semiconductor memory devices 31, as a writing destination of the data. The command processing unit 41 then duplicates writing target data by the number of the nonvolatile semiconductor memory devices 31, and writes the duplicated data in each of the identified areas in the corresponding nonvolatile semiconductor memory devices 31.

When receiving a data reading request from the host device 10, the command processing unit 41 identifies an area (logic block) corresponding to a reading source in one of the nonvolatile semiconductor memory devices 31 to be accessed. The command processing unit 41 then reads data from the identified area in the nonvolatile semiconductor memory device 31 to be accessed, and outputs the data to the host device 10. The nonvolatile semiconductor memory device 31 to be accessed can be previously defined, or dynamically switched to the other nonvolatile semiconductor memory device 31 according to load distribution. The nonvolatile semiconductor memory device 31 to be accessed is hereinafter referred to as “main memory device”, and the other nonvolatile semiconductor memory device 31 is referred to as “standby memory device”.

When a recording medium of the nonvolatile semiconductor memory device 31 is a NAND flash memory, data in a memory cell may be damaged self-discharge or due to charge displacement that occurs during reading, as described above. Accordingly, in the command processing unit 41, the recovering unit 411 reads from the standby memory device, the same data as that damaged in the main memory device, and temporarily stores the read data in the cache managing unit 412. When a writing request for an area in which a reading error occurs is issued, the command processing unit 41 generates data to be written, based on the data in the cache, and writes the generated data into the corresponding area, thereby recovering the data. That is, data stored in the standby memory device serves as recovery information for recovering data stored in the main memory device. In this way, the main memory device in which a reading error occurs can be restored to a normal state.

### <Operations of Controller 40>

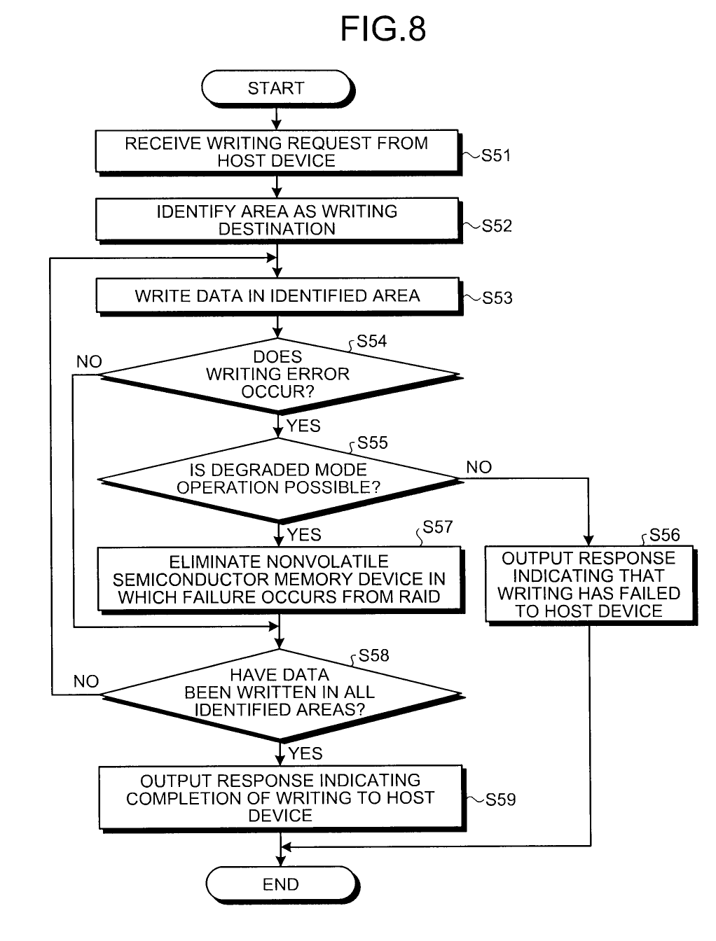

Operations of the controller 40 are explained. An operation performed to write data in the storage device 30 is first explained with reference to FIG. 8.

FIG. 8 is a flowchart of a writing process procedure performed by the controller 40. This process assumes that the storage device 30 has a RAID 1 configuration, and writing of data is performed in units of logical blocks.

When receiving a data writing request from the host device 10 through the host I/F unit 21 (Step S51), the command processing unit 41 first identifies an area in each of the nonvolatile semiconductor memory devices 31 included in the storage device 30 as a writing destination (Step S52).

The command processing unit 41 then duplicates writing target data by the number of the nonvolatile semiconductor memory devices 31, and writes the writing target data into each of the areas of the nonvolatile semiconductor memory devices 31, identified at Step S52 (Step S53). At this time, the command processing unit 41 determines whether a writing error occurs during the data writing. When determining that the writing has been performed correctly (NO at Step S54), the command processing unit 41 directly proceeds to a process at Step S58.

When a writing error is detected at Step S54 (YES at Step S54), the command processing unit 41 determines that a failure occurs in the nonvolatile semiconductor memory device 31 as the writing destination, and determines whether a degraded mode operation for maintaining the system can be performed by the remaining nonvolatile semiconductor memory device 31 other than the faulty nonvolatile semiconductor memory device 31 (Step S55). When determining that the degraded mode operation is impossible (NO at Step S55), the command processing unit 41 outputs a response indicating that the writing has failed to the host device 10 (Step S56), thereby terminating the process.

When determining that the degraded mode operation is possible (YES at Step S55), the command processing unit 41 eliminates the nonvolatile semiconductor memory device 31 in which the failure occurs from the RAID 1 configuration (Step S57), and then proceeds to a process at Step S58.

The command processing unit 41 then determines whether data have been written in all the areas identified at Step S52 (Step S58). When determining that there is an unprocessed area (NO at Step S58), the command processing unit 41 returns to the process at Step S53 to process the remaining area. When determining that data have been written in all the areas identified at Step S52 (YES at Step S58), the command processing unit 41 outputs a response indicating that the writing is completed to the host device 10 (Step S59), thereby terminating the process.

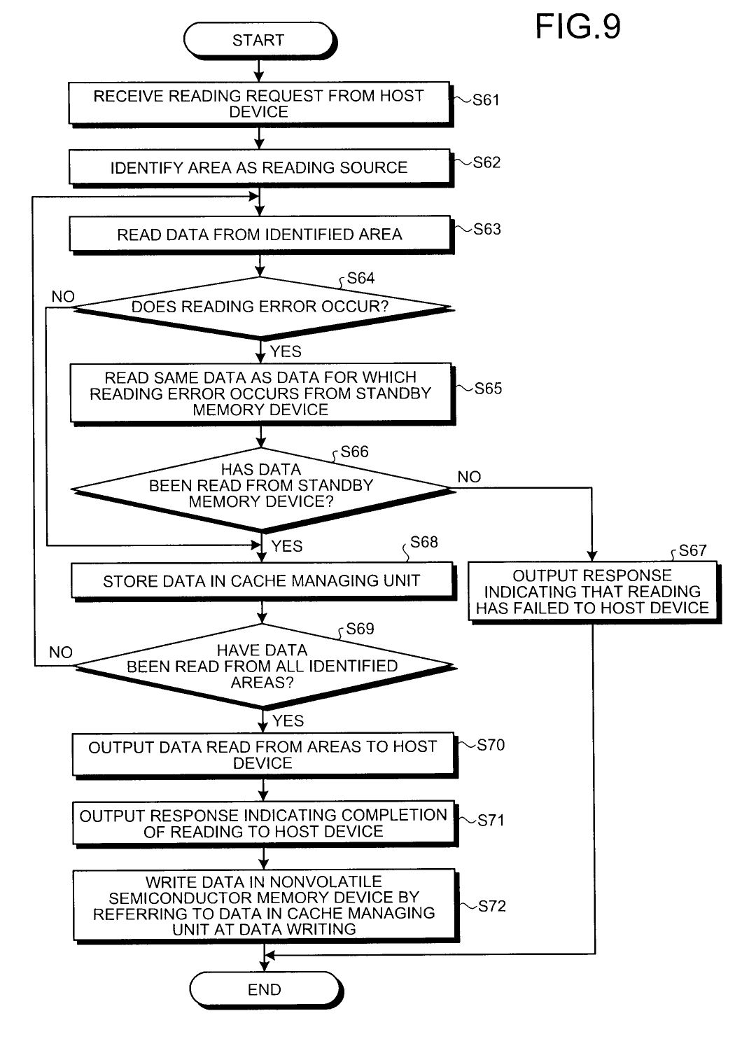

An operation performed to read data from the storage device 30 is explained with reference to FIG. 9. FIG. 9 is a flowchart of a reading process procedure performed by the controller 40. This process assumes that the storage device 30 has the RAID 1 configuration, and writing or reading of data is performed in units of logical blocks.

When receiving a data reading request from the host device 10 through the host I/F unit 21 (Step S61), the command processing unit 41 identifies an area in the main memory device, corresponding to an area as a reading source (Step S62).

The command processing unit 41 then requests the main memory device to read data in the area identified at Step S62, thereby reading target data to be read from the storage device 30 (Step S63). At this time, the command processing unit 41 determines whether a reading error occurs during the reading at Step S63 (Step S64). When determining that the reading has been performed correctly (NO at Step S64), the command processing unit 41 stores the read data in the cache managing unit 412 (Step S68), and then proceeds to a process at Step S69.

Meanwhile, when the command processing unit 41 determines at Step S64 that a reading error occurs (YES at Step S64), the recovering unit 411 reads the same data as the data for which the reading error occurs, from the standby memory device (Step S65). The recovering unit 411 then determines whether the data has been read from the standby memory device (Step S66). When determining that data has not been read from any standby memory device (NO at Step S66), the recovering unit 411 outputs a response indicating that the reading has failed to the host device 10 (Step S67), thereby terminating the process.

When determining at Step S66 that data has been read from the standby memory device (YES at Step S66), the recovering unit 411 stores the data read at Step S65 in the cache managing unit 412 (Step S68), and then proceeds to a process at Step S69.

The command processing unit 41 then determines whether data have been read from all the areas identified at Step S62 (Step S69). When determining that there is an unprocessed area (NO at Step S69), the command processing unit 41 returns to the process at Step S63 to process the next area. When determining that data have been read from all the areas identified at Step S62 (YES at Step S69), the command processing unit 41 outputs the data read from the areas to the host device 10 (Step S70). The command processing unit 41 then outputs a response indicating completion of the reading to the host device 10 (Step S71), and writes data in the nonvolatile semiconductor memory device 31 by referring to the data in the cache managing unit 412 at the time of data writing (Step S72), as described below, thereby terminating the process.

When a reading error occurs at Step S64, it implies that the recovered data is stored only in the cache managing unit 412, which causes a state in which the data in the nonvolatile semiconductor memory devices 31 are inconsistent with the data in the cache managing unit 412. However, consistency can be maintained by writing data into the nonvolatile semiconductor memory devices 31 by referring to the data in the cache managing unit 412 at the time of writing of the data, for example. Accordingly, it is possible to prevent a situation in which a longer writing time is required when data are written into the nonvolatile semiconductor memory devices 31, a reading process is not completed, and output to a data requesting source (the host device) is delayed.

As described above, according to the second embodiment, when an error occurs during reading, data for which the reading error occurs is recovered and stored in the cache managing unit 412. The data is then written into an area of the nonvolatile semiconductor memory device 31 in which the reading error occurs, upon receipt of a writing request, thereby restoring the nonvolatile semiconductor memory device 31 to a normal state. In this way, the plural nonvolatile semiconductor memory devices 31 arranged in the RAID configuration can be effectively utilized.

While exemplary embodiments of the present invention have been explained above, the invention is not limited thereto, and various modifications, substitutions, and additions can be made without departing from the scope of the invention. Furthermore, various inventions can be created by combinations of the constituent elements disclosed in the above embodiments. For example, some of the whole constituent elements disclosed in the embodiments can be omitted. Further, the constituent elements according to different embodiments can be suitably combined with each other.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A storage control device comprising:
at least one interface capable of connecting to plural nonvolatile semiconductor memory devices;
a configuring unit that configures a redundant array of independent/inexpensive disks (RAID) for storing therein storage target data and recovery information that enables recovery of the storage target data, the RAID including the plural nonvolatile semiconductor memory devices;
a reading unit that reads data from the nonvolatile semiconductor memory devices included in the RAID, in response to a data reading request inputted from outside;
a recovering unit that recovers data for which an error occurs during reading by the reading unit, based on the recovery information;
a storing unit that temporarily stores therein the data recovered by the recovering unit; and
a writing unit that writes the data stored in the storing unit, into an area of the nonvolatile semiconductor memory device in which the reading error for the data occurs.

2. The device according to claim 1, further including a writing unit that writes data in the nonvolatile semiconductor memory devices included in the RAID, in response to a data writing request inputted from outside, wherein
the configuring unit eliminates the nonvolatile semiconductor memory device in which an error occurs during the writing by the writing unit, from the RAID configuration.

3. The device according to claim 2, wherein the configuring unit eliminates the nonvolatile semiconductor memory device in which the writing error occurs, from the RAID configuration, when the RAID configuration can be maintained by the nonvolatile semiconductor memory devices other than the nonvolatile semiconductor memory device in which the writing error occurs.

4. The device according to claim 1, wherein each of the nonvolatile semiconductor memory devices refreshes data stored in a recording medium thereof.

5. The device according to claim 1, wherein each of the nonvolatile semiconductor memory devices has a NAND flash memory as a recording medium.

6. The device according to claim 1, wherein the configuring unit configures one of RAID 1, RAID 5, RAID 6, and a combination of any of RAID 1, RAID 5, and RAID 6 using the plural nonvolatile semiconductor memory devices.

7. A storage control method of a storage control device which configures a redundant array of independent/inexpensive disks (RAID) for storing therein storage target data and recovery information that enables recovery of the storage target data using plural nonvolatile semiconductor memory devices, the method comprising:
reading data from the nonvolatile semiconductor memory devices included in the RAID, in response to a data reading request inputted from outside;
recovering data, for which an error occurs during reading in the reading, based on the recovery information;
temporarily storing the data recovered in the recovering;
writing the data stored in the temporarily storing, into an area of the nonvolatile semiconductor memory device in which the reading error for the data occurs.
